(19) United States
(12) Patent Application Publication
(10) Pub. No.: US 2026/0093057 A1
(43) Pub. Date: Apr. 2, 2026

(54) DISPLAY DEVICE, METHOD OF INSPECTING THE DISPLAY DEVICE, AND ELECTRONIC DEVICE INCLUDING THE DISPLAY DEVICE

(71) Applicant: Samsung Display Co., Ltd., Yongin-si, (KR)

(72) Inventors: Hyo Seok YANG, Yongin-si (KR); Young Moo KWON, Yongin-si (KR); Young Kwan KIM, Yongin-si (KR); Young Dae SONG, Yongin-si (KR); Hee Sung LIM, Yongin-si (KR)

(21) Appl. No.: 19/212,397

(22) Filed: May 19, 2025

(30) Foreign Application Priority Data
Oct. 2, 2024 (KR) 10-2024-0133832

(51) Int. Cl. G02B 5/00; G01B 11/27

(52) U.S. Cl. CPC G02B 5/003; G01B 11/272; G02B 2207/123

(57) ABSTRACT

A display device may include a display panel including pixels in a display area, a light control layer over the display panel, and including light-blocking components arranged in a second direction, and extending in a first direction crossing the second direction, a polarizing layer over the light control layer, and a visibility enhancement component along an edge of the polarizing layer in plan view.

### CROSS-REFERENCE TO RELATED APPLICATION

The present application claims priority to, and the benefit of, Korean Patent Application Number 10-2024-0133832, filed on Oct. 2, 2024, in the Korean Intellectual Property Office, the entire disclosure of which is incorporated herein by reference.

### BACKGROUND

### 1. Field

Various embodiments of the present disclosure relate to a display device, a method of inspecting the display device, and an electronic device including the display device.

### 2. Description of Related Art

Display devices may include a stacked structure formed by stacking components with various functions. For example, the stacked structure may include first to third components stacked in a thickness direction. If some components are misaligned with respect to others during the formation of the stacked structure, the display quality of the display device including the stacked structure may deteriorate.

### SUMMARY

Various embodiments of the present disclosure are directed to a display device with improved display quality.

Various embodiments of the present disclosure are directed to a method of inspecting a display device with enhanced reliability.

One or more embodiments of the present disclosure may provide a display device including a display panel including pixels in a display area, a light control layer over the display panel, and including light-blocking components arranged in a second direction, and extending in a first direction crossing the second direction, a polarizing layer over the light control layer, and a visibility enhancement component along an edge of the polarizing layer in plan view.

The visibility enhancement component may have a linear shape in plan view.

A line width of the visibility enhancement component may be greater than a width of each of the light-blocking components in the second direction.

The line width of the visibility enhancement component may be about 80 micrometers or more and about 120 micrometers or less.

The visibility enhancement component may overlap a peripheral area around the display area.

The visibility enhancement component may include sub-visibility enhancement components spaced apart from each other, and at edges of the polarizing layer adjacent to corners of the polarizing layer in plan view.

The polarizing layer may include an adhesive layer over the light control layer, functional layers over the adhesive layer, and a protective film layer over the functional layers.

The visibility enhancement component may be over the protective film layer.

The visibility enhancement component may be between the protective film layer and the functional layers.

The visibility enhancement component may be between two adjacent ones of the functional layers.

The visibility enhancement component may include a light-blocking material.

One or more embodiments of the present disclosure may provide a method of inspecting a display device including a display panel including pixels in a display area, a light control layer over the display panel and including light-blocking components arranged in a second direction and extending in a first direction crossing the second direction, a polarizing layer over the light control layer, and a visibility enhancement component along an edge of the polarizing layer in plan view, the method including identifying the visibility enhancement component from an image captured of the display device, and inspecting for misalignment of the polarizing layer based on the visibility enhancement component.

The inspecting for the misalignment of the polarizing layer may include setting a first reference point corresponding to a first corner of the display panel in the image, setting a second reference point corresponding to a second corner of the polarizing layer adjacent to the first corner in the image, and determining a relative position of the second reference point based on a position of the first reference point.

The setting the first reference point may include setting a 1-1-th reference line segment overlapping an edge of the display panel adjacent to the first corner in the image, setting a 1-2-th reference line segment overlapping another edge of the display panel adjacent to the first corner in the image, and setting an intersection point of an extension line of the 1-1-th reference line segment and an extension line of the 1-2-th reference line segment to the first reference point.

The setting the second reference point may include setting a 2-1-th reference line segment overlapping a portion of the visibility enhancement component adjacent to the second corner in the image, setting a 2-2-th reference line segment overlapping another portion of the visibility enhancement component adjacent to the second corner in the image, and setting another intersection point of an extension line of the 2-1-th reference line segment and an extension line of the 2-2-th reference line segment to the second reference point.

The determining the relative position of the second reference point may include determining a first spacing distance between the first reference point and the second reference point based on a first reference direction in the image, and determining a second spacing distance between the first reference point and the second reference point based on a second reference direction that is substantially perpendicular to the first reference direction in the image.

The inspecting for the misalignment of the polarizing layer may include comparing the first spacing distance with a first reference distance, and comparing the second spacing distance with a second reference distance.

Inspecting for the misalignment of the polarizing layer may include determining that the polarizing layer has been normally aligned when the first spacing distance is less than or equal to the first reference distance, and the second spacing distance is less than or equal to the second reference distance.

One or more embodiments of the present disclosure may provide an electronic device including a display device configured to display an image, and including a display panel including pixels in a display area, a light control layer over the display panel, and including light-blocking components arranged in a second direction and extending in a first direction crossing the second direction, a polarizing layer over the light control layer, and a visibility enhancement component along an edge of the polarizing layer in plan view.

The electronic device may include a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, a head-mounted display (HMD), a virtual reality (VR) device, an augmented reality (AR) device, a dashboard of a vehicle, a center information display (CID), or a mirror display.

### BRIEF DESCRIPTION OF THE DRAWINGS

FIG. 1 is a diagram for describing a display system in accordance with embodiments.

FIG. 2 is a plan view for describing a display device in accordance with embodiments.

FIG. 3 is a sectional view taken along line X1-X2 of FIG. 2.

FIG. 4 is an enlarged sectional view of area AR1 of FIG. 3.

FIGS. 5 and 6 are plan views for describing various embodiments of a visibility enhancement component of FIG. 3.

FIGS. 7 to 9 are sectional views for describing various embodiments of a visibility enhancement component of FIG. 3.

FIG. 10 is a flowchart for describing a method of inspecting a display device in accordance with embodiments.

FIG. 11 is a diagram for describing one or more embodiments of an image captured of the display device.

FIG. 12 is a diagram for describing one or more embodiments of the method of inspecting the display device using an image of FIG. 11.

FIG. 13 is a block diagram of an electronic device according to one or more embodiments.

FIG. 14 shows schematic views of various embodiments of an electronic device.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions, such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B”may include A, B, or A and B.

Similarly, expressions, such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5 % of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

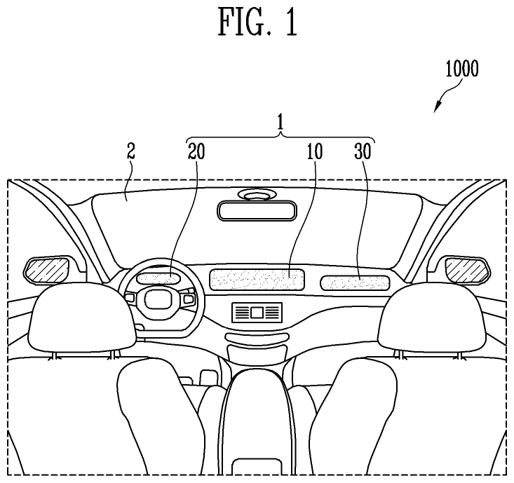

FIG. 1 is a diagram for describing a display system in accordance with embodiments.

Referring to FIG. 1, a passenger compartment of the vehicle 1000 is illustrated. The vehicle 1000 may refer to various apparatuses for transporting subjects, such as humans, objects, or animals, from a departure point to a destination. The vehicle 1000 may include vehicles traveling on roads or tracks, vessels moving over seas or rivers, or aircrafts flying through the sky by means of air dynamics.

In one or more embodiments, a display device 1 is installed in the passenger compartment of the vehicle 1000 to provide an image (or video). In one or more embodiments, the display device 1 may include an infotainment panel 10, a cluster 20, and a co-driver display 30. Each of the infotainment panel 10, the cluster 20, and the co-driver display 30 may be configured as a display device that displays an image (or video) to provide information suitable for driving the vehicle 1000, or to provide various other information to a driver (or passenger).

In one or more embodiments, light emitted from the display device 1 may travel in a corresponding direction. For example, light emitted from the display device 1 may travel toward a driver's seat (or passenger seat). In this case, when light emitted from the display device 1 travels toward a windshield 2, the light emitted from the display device 1 may be reflected by the windshield 2 to reach the driver's seat. Therefore, the driver may recognize the image of the display device 1 formed on the windshield 2, which may compromise safety while driving as the driver may not be able to recognize objects in front of the vehicle 1000.

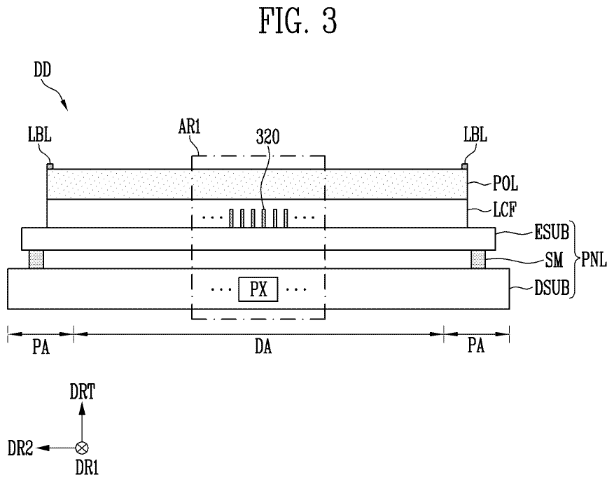

To reduce or prevent the likelihood of the aforementioned problem, the display device 1 according to the present disclosure may include a light control layer LCF configured to reduce or prevent light emitted from the display device 1 from traveling unintended directions. Details of the foregoing will be described below with reference to FIG. 3.

The display device 1 according to one or more embodiments is a device for displaying a video or still image, and may be used as a display screen for various products, such as television, laptops, monitors, billboards, Internet of Things (IoTs), as well as portable electronic devices, such as mobile phone, smart phone, smart pad, tablet personal computer (PC), mobile communication terminal, electronic notebook, electronic book, portable multimedia player PMP, personal digital assistant PDA, MP3 player, navigation system, and ultra mobile PC UMPC. In addition, the display device 1 according to one or more embodiments may be used in wearable devices, such as smart watches, watch phones, glasses-type displays, head-mounted displays HMDs, virtual reality (VR) devices, or augmented reality (AR) devices. In addition, the display device 1 according to one or more embodiments may be used as a dashboard of a vehicle, a center information display (CID) located in a center fascia or a dashboard of the vehicle, a room mirror display replacing a side mirror of the vehicle, an entertainment element for a rear seat of the vehicle, and a display located on a rear surface of the front seat.

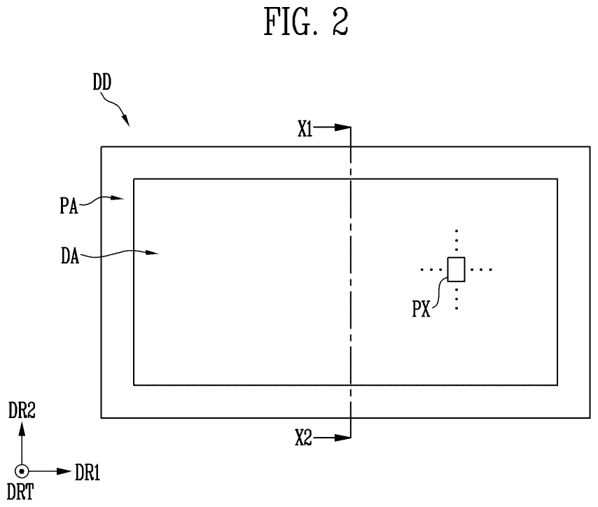

FIG. 2 is a plan view for describing a display device DD in accordance with embodiments.

Referring to FIG. 2, the display device DD may be applied to the display device 1 described with reference to FIG. 1. For example, the display device DD may be implemented as the infotainment panel 10, the cluster 20, and the co-driver display 30.

In one or more embodiments, the display device DD may include a display area DA and a peripheral area PA. A plurality of pixels PX may be located in the display area DA. Each of the pixels PX may emit light. The display device DD may display an image (or video) by a combination of light emitted from the pixels PX. The peripheral area PA may be an area formed around the display area DA. In one or more embodiments, a driver for driving the pixels PX may be located in the peripheral area PA.

FIG. 3 is a sectional view taken along line X1-X2 of FIG. 2.

Referring to FIGS. 2 and 3, the display device DD may include a display panel PNL, a light control layer LCF, a polarizing layer POL, and a visibility enhancement component LBL.

In one or more embodiments, the display panel PNL may include a display substrate DSUB, a sealing component SM, and an encapsulation substrate ESUB. In one or more embodiments, the display substrate DSUB may include the plurality of pixels PX located in the display area DA, and the driver located in the peripheral area PA. The encapsulation substrate ESUB may be located on the display substrate DSUB (as used herein, “located on” may mean “above”). The sealing component SM may be located between the display substrate DSUB and the encapsulation substrate ESUB, and may support an encapsulation substrate ESUB. In one or more embodiments, the sealing component SM may be located in the peripheral area PA, and may enclose the display area DA. Accordingly, the pixels PX located in the display area DA may be sealed by the sealing component SM and the encapsulation substrate ESUB, thereby being protected from external water and dust.

The light control layer LCF may be located over the display panel PNL. The light control layer LCF may include a plurality of light-blocking components 320. The light-blocking components 320 may be arranged in a second direction DR2. Each of the light-blocking components 320 may extend in a first direction DR1 crossing the second direction DR2. Each of the light-blocking components 320 may have a corresponding (e.g., suitable) thickness in a thickness direction DRT that is substantially perpendicular to the first and second directions DR1 and DR2. The light-blocking components 320 may overlap at least the display area DA. Because the light-blocking components 320 have the above-mentioned configuration, the corresponding direction in which light emitted from the pixels PX travels can be controlled. For example, the plurality of light-blocking components 320 may be provided to reduce or prevent light, which is emitted from the display device 1, traveling in a direction toward the windshield 2.

The polarizing layer POL may be located on the light control layer LCF. The polarizing layer POL may reduce the reflectivity of light (e.g., external light) incident on the display device DD from the outside. Hence, the display quality of the display device DD may be enhanced.

As illustrated in FIG. 3, because the light control layer LCF is located between the display panel PNL and the polarizing layer POL, a distance in the thickness direction DRT between the light-blocking components 320 included in the light control layer LCF and the pixels PXL included in the display panel PNL may be relatively reduced. Accordingly, it is possible to reduce or prevent the likelihood of a ghost image forming on an image (or video) displayed on the display device DD.

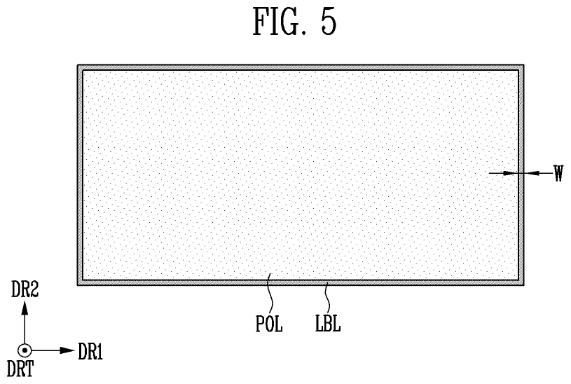

The visibility enhancement component LBL may be located along an edge of the polarizing layer POL. The visibility enhancement component LBL will be described with reference to FIGS. 5 to 9.

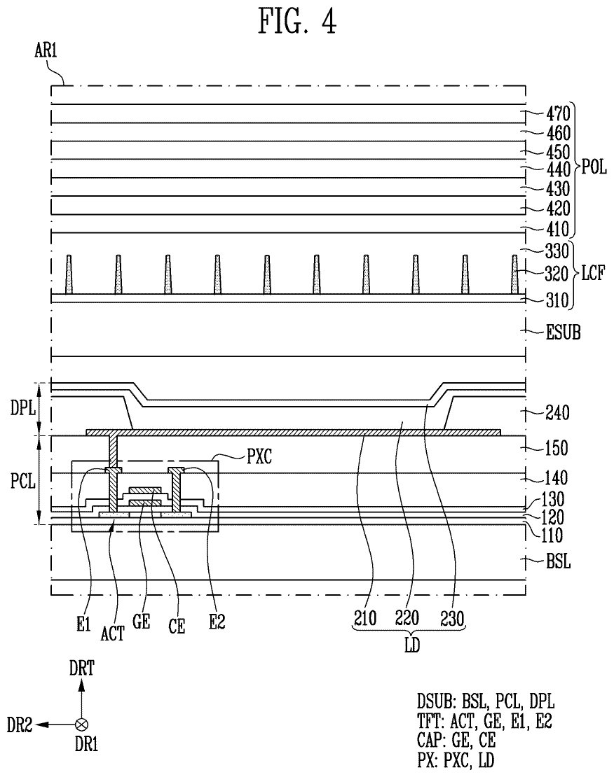

FIG. 4 is an enlarged sectional view of area AR1 of FIG. 3.

Referring to FIG. 4, an enlargement of area AR1 that is a portion of the display area DA is illustrated.

In one or more embodiments, the pixel substrate DSUB may include a base layer BSL, a pixel circuit layer PCL, and a display element layer DPL.

The base layer BSL may function as a foundation for components located on the base layer BSL. In one or more embodiments, the base layer BSL may include glass, plastic, polymer materials, or composite materials thereof.

The pixel circuit layer PCL may be located on the base layer BSL. The pixel circuit layer PCL may include a plurality of insulating layers and a circuit element PXC.

In one or more embodiments, the plurality of insulating layers may include first to fifth insulating layers 110, 120, 130, 140, and 150 that are sequentially stacked in the thickness direction DRT. Each of the first to fifth insulating layers 110, 120, 130, 140, and 150 may have a single-layer or multilayer structure including inorganic insulating material and/or organic insulating material. However, embodiments are not limited to the aforementioned structure. In the case where the number of conductive layers (or semiconductor layers) needed to form the circuit element PXC is reduced or increased, the plurality of insulating layers may include four or fewer insulating layers or six or more insulating layers.

The circuit element PXC may include a transistor TFT and a capacitor CAP. The transistor TFT may include a semiconductor layer ACT, a first electrode E1, a second electrode E2, and a gate electrode GE. The capacitor CAP may include a gate electrode GE and a capacitor electrode CE.

The semiconductor layer ACT may be located on the first insulating layer 110. The second insulating layer 120 may cover the semiconductor layer ACT on the first insulating layer 110. In one or more embodiments, the semiconductor layer ACT may include single crystal silicon, polycrystalline silicon, and/or an oxide semiconductor.

The gate electrode GE may be located on the second insulating layer 120. The third insulating layer 130 may cover the gate electrode GE on the second insulating layer 120. The gate electrode GE may overlap a first portion of the semiconductor layer ACT. In this case, the first portion of the semiconductor layer ACT may form a channel of the transistor TFT. Second portions of the semiconductor layer ACT that do not overlap the gate electrode GE may form a source terminal and a drain terminal of the transistor TFT.

The capacitor electrode CE may be located on the third insulating layer 130. The fourth insulating layer 140 may cover the capacitor electrode CE on the third insulating layer 130. The capacitor electrode CE may overlap a portion of the gate electrode GE to form the capacitor CAP.

The first electrode E1 and the second electrode E2 may be located on the fourth insulating layer 140. The fifth insulating layer 150 may cover the first and second electrodes E1 and E2 on the fourth insulating layer 140. The first electrode E1 and the second electrode E2 may be respectively connected to the second portions of the semiconductor layer ACT (e.g., the source terminal and the drain terminal of the transistor TFT) through contact holes formed in the second to fourth insulating layers 120, 130, and 140.

The display element layer DPL may include a light-emitting element LD and a pixel-defining layer 240. The light-emitting element LD may include a pixel electrode 210, an intermediate layer 220, and a common electrode 230.

The pixel electrode 210 may be located on the pixel circuit layer PCL. The pixel electrode 210 may be electrically connected to the circuit element PXC, and may be supplied with an electrical signal from the circuit element PXC. In one or more embodiments, the pixel electrode 210 may be referred to as an anode electrode.

The pixel-defining layer 240 may be located over the pixel circuit layer PCL and the pixel electrode 210, and may include a pixel opening that exposes at least a portion of the pixel electrode 210. The pixel-defining layer 240 may define an area where light is emitted from the light-emitting element LD.

The intermediate layer 220 may be located over the pixel electrode 210, which is at least partially exposed through the pixel opening of the pixel-defining layer 240. In one or more embodiments, the intermediate layer 220 may include at least organic light-emitting material. In this case, the intermediate layer 220 may emit light based on electrical signals provided from the pixel electrode 210 and the common electrode 230.

The common electrode 230 may be located over the intermediate layer 220. In one or more embodiments, the common electrode 230 may be configured to be substantially transparent or translucent to meet a corresponding (e.g., suitable) light transmittance. For example, the common electrode 230 may include indium tin oxide (ITO). In one or more embodiments, the common electrode 230 may be referred to as a cathode electrode.

The light-emitting element LD of the display element layer DPL, and the circuit element PXC of the pixel circuit layer PCL that is electrically connected to the light-emitting element LD, may define a pixel PX. Here, the pixel PX may refer to a minimum unit required for emitting light.

The encapsulation substrate ESUB may be located over the display element layer DPL. As described above, the pixel PX may be sealed by the encapsulation substrate ESUB and the sealing component SM (refer to FIG. 3).

The light control layer LCF may be located over the encapsulation substrate ESUB. In one or more embodiments, the light control layer LCF may include an adhesive layer 310, the plurality of light-blocking components 320, and a light-transmitting component 330.

The adhesive layer 310 may be located over the encapsulation substrate ESUB, and may secure components located on the adhesive layer 310 to the encapsulation substrate ESUB. In one or more embodiments, the adhesive layer 310 may be omitted. In this case, the light-blocking components 320 and the light-transmitting component 330 may be directly located on the encapsulation substrate ESUB.

The light-blocking components 320 may be arranged in the second direction DR2. Each of the light-blocking components 320 may extend in the first direction DR1, and may have a corresponding (e.g., suitable) thickness in the thickness direction DRT. The light-blocking components 320 may overlap the light-emitting element LD, and may control the direction of light emitted from the light-emitting element LD in a corresponding direction. In one or more embodiments, the light-blocking components 320 may include at least one of various known light-blocking materials.

The light-transmitting component 330 may be located between at least the light-blocking components 320. In one or more embodiments, as illustrated in FIG. 4, the light-transmitting component 330 may cover the light-blocking components 320. In one or more embodiments, the light-transmitting component 330 may include insulating material having a corresponding (e.g., suitable) light transmittance.

The polarizing layer POL may be located on the light control layer LCF. In one or more embodiments, the polarizing layer POL may include the adhesive layer 410 located over the light control layer LCF, a plurality of functional layers 420, 430, 440, 450, and 460 located over the adhesive layer 410, and a protective film layer 470 located over the functional layers 420, 430, 440, 450, and 460.

The adhesive layer 410 may be located over the light control layer LCF, and may secure components located on the adhesive layer 410 to the light control layer LCF. In one or more embodiments, the adhesive layer 410 may be omitted. In this case, the functional layers 420, 430, 440, 450, and 460 may be directly located on the light control layer LCF.

In one or more embodiments, the functional layers 420, 430, 440, 450, and 460 may include first to fifth functional layers 420, 430, 440, 450, and 460. The first to fifth functional layers 420, 430, 440, 450, and 460 may be formed of various layers functioning to reduce the reflectance of light (e.g., external light) incident toward the display device DD from the outside.

In one or more embodiments, the first functional layer 420 may be referred to as a phase retardation layer. The phase retardation layer may include a λ/2 phase retarder and/or a λ/4 phase retarder. The phase retardation layer may delay the phase of light that is reflected by and returned from the conductive layers in the display panel PNL. For example, the phase retardation layer may delay the reflected light by a λ/4, thereby allowing the reflected light to be circularly polarized. Accordingly, the visibility of the reflected light can be reduced.

In one or more embodiments, the second functional layer 430 may function as an adhesive layer. For example, the second functional layer 430 may be located over the first functional layer 420, thereby functioning to secure components located on the second functional layer 430 to the first functional layer 420.

In one or more embodiments, the third functional layer 440 may function as a protective layer. For example, the third functional layer 440 may support the fourth functional layer 450 located over the third functional layer 440, thereby reinforcing the mechanical strength of the fourth functional layer 450. In this case, in one or more embodiments, the third functional layer 440 may include tri-acetyl cellulous (TAC), cycloolefin polymer, and/or polymethyl methacrylate (PMMA).

In one or more embodiments, the fourth functional layer 450 may polarize light (e.g., external light) incident from the outside in the same direction as the polarization axis. Accordingly, the visibility of the external light can be reduced.

In one or more embodiments, the fifth functional layer 460 may function as a protective layer. For example, the fifth functional layer 460 may be located over the fourth functional layer 450, thus protecting the fourth functional layer 450 from external impacts. In this case, the fifth functional layer 460 may include a material identical (or similar) to the material that constitutes the third functional layer 440 described above, according to one or more embodiments.

The first to fifth functional layers 420, 430, 440, 450, and 460 are not limited to the foregoing description. The first to fifth functional layers 420, 430, 440, 450, and 460 may include various known functional layers required for performing the function of the polarizing layer POL. In this case, at least one of the first to fifth functional layers 420, 430, 440, 450, and 460 may be omitted, or other functional layers except for the first to fifth functional layers 420, 430, 440, 450, and 460 may be further provided.

The protective film layer 470 may be located over the fifth functional layer 460. The protective film layer 470 may protect components located under the protective film layer 470 from foreign substances. In one or more embodiments, the protective film layer 470 may be temporarily provided, and may be removed after the display device DD is applied to a final product (e.g., the display device 1 of FIG. 1).

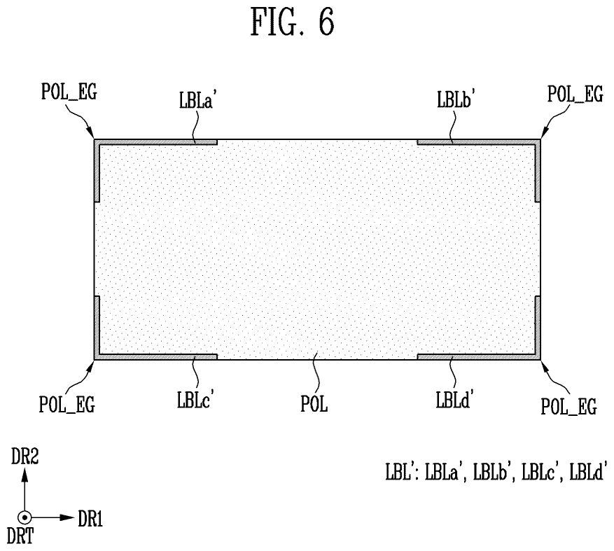

Hereinafter, various embodiments of a planar shape of the visibility enhancement component LBL will be described with reference to FIGS. 5 and 6.

FIGS. 5 and 6 are plan views for describing various embodiments of the visibility enhancement component LBL of FIG. 3. FIG. 5 is a plan view for describing the visibility enhancement component LBL in accordance with one or more embodiments. FIG. 6 is a plan view for describing the visibility enhancement component LBL in accordance with one or more other embodiments.

Referring to FIGS. 3 and 5, the visibility enhancement component LBL in accordance with one or more embodiments may be located along the edge of the polarizing layer POL on a plane defined in the first direction DR1 and the second direction DR2. The visibility enhancement component LBL may include light-blocking material and, therefore, may serve to enhance the visibility of the edge of the polarizing layer POL in a method of inspecting the display device DD to be described below.

In one or more embodiments, the visibility enhancement component LBL may have a closed-loop shape that is entirely located along the edge of the polarizing layer POL on the plane.

In one or more embodiments, the visibility enhancement component LBL may have a linear shape on the plane. In this case, on the plane, a line width W of the visibility enhancement component LBL may be greater than a width of the plurality of light-blocking components 320 in the second direction DR2. Accordingly, in the method of inspecting the display device DD to be described below, the visibility enhancement component LBL may be clearly distinguishable and identifiable from the plurality of light-blocking components 320.

In this case, for example, the line width W of the visibility enhancement component LBL may be approximately 80 micrometers or more, and may be approximately 120 micrometers or less. In the case where the line width W of the visibility enhancement component LBL meets the aforementioned numerical range, the visibility enhancement component LBL may be clearly distinguished and identified from the plurality of light-blocking components 320, and perceptibility by a user of the display device DD may be effectively reduced or prevented.

In one or more embodiments, the visibility enhancement component LBL may overlap the peripheral area PA. In this case, the visibility enhancement component LBL may not overlap the display area DA. Accordingly, blocking of light emitted from the pixels PX by the visibility enhancement component LBL may be reduced or prevented.

Referring to FIGS. 3 and 6, a visibility enhancement component LBL′ in accordance with one or more other embodiments may be described as being substantially the same as the visibility enhancement component LBL in accordance with the previous embodiments, except for the planar shape. Therefore, explanations pertaining to content that overlaps the details described with reference to FIG. 5 will be omitted.

In one or more embodiments, the visibility enhancement component LBL′ may include a plurality of sub-visibility enhancement components LBLa′, LBLb′, LBLc′, and LBLd′ that are spaced apart from each other, and that are located on edges of the polarizing layer POL that are adjacent to respective corners POL_EG of the polarizing layer POL. As the visibility enhancement component LBL′ have the aforementioned configuration, perception by the user of the display device DD of the visibility enhancement component LBL′ can be more effectively reduced or prevented as compared to the visibility enhancement component LBL described with reference to FIG. 5.

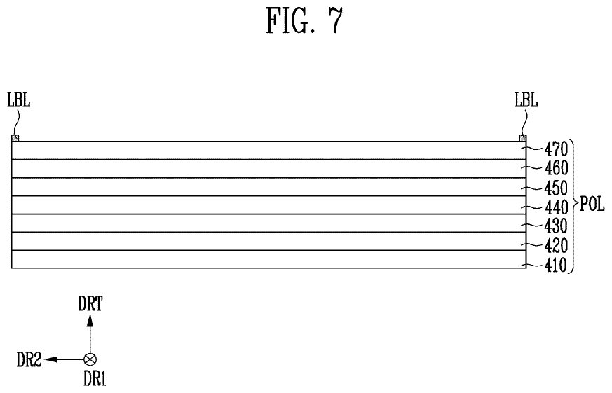

Hereinafter, various embodiments of a cross-sectional disposition of the visibility enhancement component LBL will be described with reference to FIGS. 7 to 9. Here, for the sake of clear and concise explanation, the following description will be based on the visibility enhancement component LBL of FIG. 5, and the description may be similarly applied to the visibility enhancement component LBL′ of FIG. 6.

FIGS. 7 to 9 are sectional views for describing various embodiments of the visibility enhancement component LBL of FIG. 3.

Referring to FIG. 7, in one or more embodiments, the visibility enhancement component LBL may be located on the protective film layer 470.

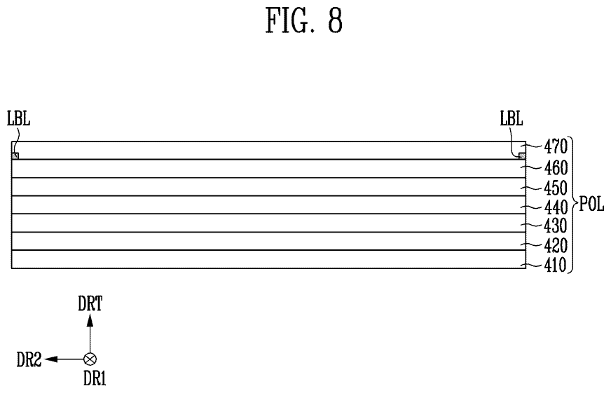

Unlike the aforementioned structure, referring to FIG. 8, in one or more other embodiments, the visibility enhancement component LBL may be located between the protective film layer 470 and the fifth functional layer 460.

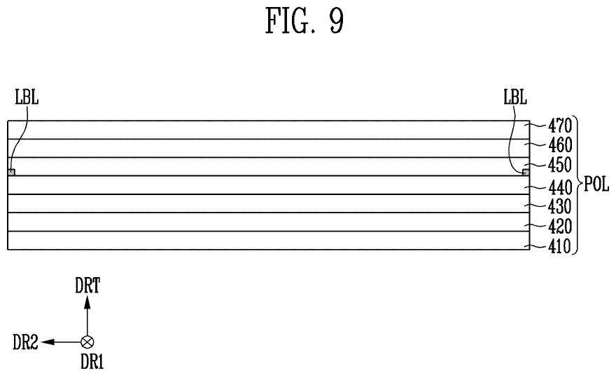

Unlike the aforementioned structure, referring to FIG. 9, in one or more other embodiments, the visibility enhancement component LBL may be located between two functional layers among the first to fifth functional layers 420, 430, 440, 450, and 460. For example, the visibility enhancement component LBL may be located between the third functional layer 440 and the fourth functional layer 450.

As described above, the visibility enhancement component LBL may be located over (or under) any one layer among various layers that constitute the polarizing layer POL.

In one or more embodiments where the visibility enhancement component LBL is provided to contact the protective film layer 470 (e.g., refer to FIGS. 7 and 8), the visibility enhancement component LBL may be bonded and attached to the protective film layer 470. In this case, when the protective film layer 470 is removed, the visibility enhancement component LBL, which is bonded and attached to the protective film layer 470, may also be removed concurrently or substantially simultaneously.

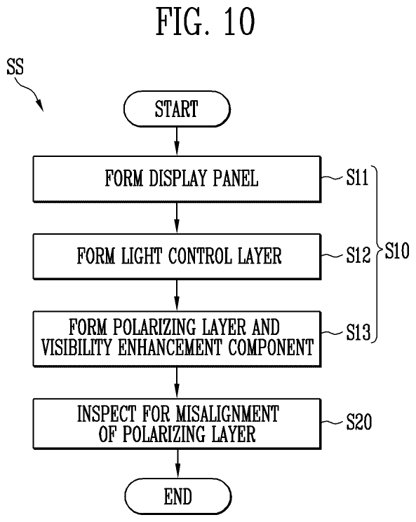

FIG. 10 is a flowchart for describing a method SS of inspecting the display device DD in accordance with embodiments.

In the following description of the method SS of inspecting the display device DD, explanations of content that overlap the details described with reference to FIGS. 2 to 9 may be omitted.

Referring to FIG. 10, the method SS of inspecting the display device DD may include operation S11 of forming the display panel PNL, operation S12 of forming the light control layer LCF, operation S13 of forming the polarizing layer POL and the visibility enhancement component LBL, and operation S20 of inspecting for misalignment of the polarizing layer POL.

Operation S11 of forming the display panel PNL, operation S12 of forming the light control layer LCF, and operation S13 of forming the polarizing layer POL and the visibility enhancement component LBL are included in operation S10 of forming the display device DD. At operation S10 of forming the display device DD, the display device DD including the display panel PNL, the light control layer LCF, the polarizing layer POL, and the visibility enhancement component LBL (or LBL′), as described with reference to FIGS. 2 to 9, may be formed.

Operation S13 of forming the polarizing layer POL and the visibility enhancement component LBL may include the operation of attaching the polarizing layer POL provided with the visibility enhancement component LBL onto the light control layer LCF, or the operation of attaching the polarizing layer POL onto the light control layer LCF and then forming the visibility enhancement component LBL on the polarizing layer POL.

In this case, after operation S13 of forming the polarizing layer POL and the visibility enhancement component LBL, operation S20 of inspecting for misalignment of the polarizing layer POL may be performed. At operation S20 of inspecting for misalignment of the polarizing layer POL, the misalignment of the polarizing layer POL may be inspected based on the visibility enhancement component LBL identified from an image captured of the display device DD.

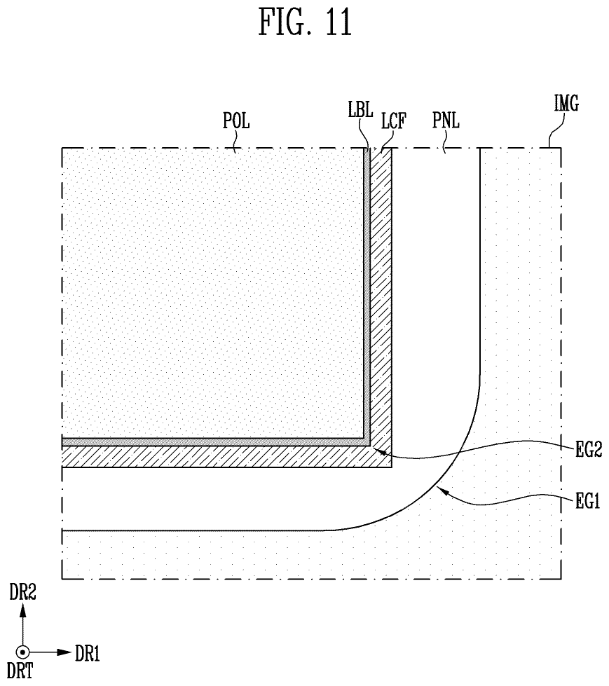

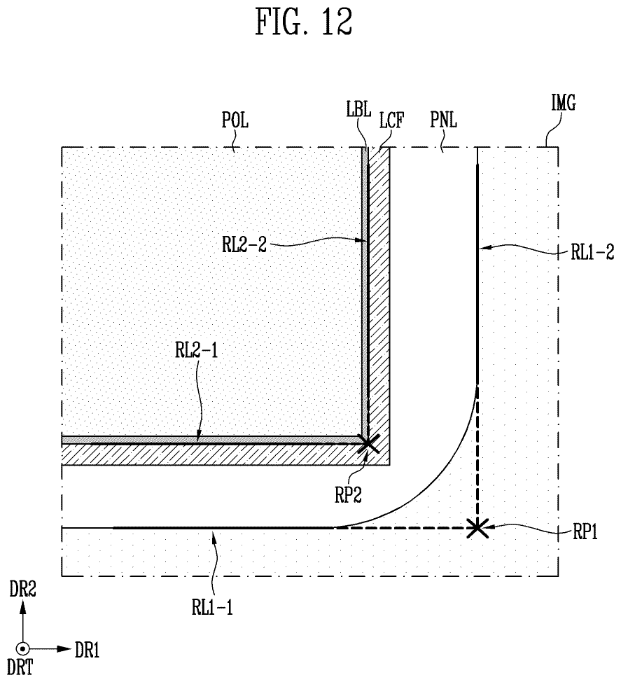

FIG. 11 is a diagram for describing one or more embodiments of an image IMG captured of the display device. FIG. 12 is a diagram for describing one or more embodiments of the method of inspecting the display device using an image of FIG. 11.

Referring to FIG. 11, the display panel PNL, the light control layer LCF, the polarizing layer POL, and the visibility enhancement component LBL may each be identified in the image IMG.

For the sake of concise explanation, FIG. 11 illustrates an image IMG pertaining to a first corner EG1 of the display panel PNL, a second corner EG2 of the polarizing layer POL adjacent to the first corner EG1, and portions of components of the display device DD adjacent to the first and second corners EG1 and EG2. The following description may be identically (or similarly) applied to other corners of the display panel PNL, other corners of the polarizing layer POL adjacent to the corners of the display panel PNL, and components of the display device DD adjacent to the corners.

Referring to FIGS. 11 and 12, in one or more embodiments, operation S20 of inspecting for misalignment of the polarizing layer POL may include the operation of setting a first reference point RP1 corresponding to the first corner EG1 of the display panel PNL in the image IMG, the operation of setting a second reference point RP2 corresponding to the second corner EG2 of the polarizing layer POL in the image IMG, and the operation of determining a relative position of the second reference point RP2 based on a position of the first reference point RP1.

In one or more embodiments, the operation of setting the first reference point RP1 may include the operation of setting, in the image IMG, a 1-1-th reference line segment RL1-1 overlapping an edge of the display panel PNL adjacent to the first corner EG1, the operation of setting, in the image IMG, a 1-2-th reference line segment RL1-2 overlapping another edge of the display panel PNL adjacent to the first corner EG1, and the operation of setting an intersection point between an extension line of the 1-1-th reference line segment RL1-1 and an extension line of the 1-2-th reference line segment RL1-2 to the first reference point RP1. As the first reference point RP1 is set as described above, the first reference point RP1, which serves as a criterion for determining the misalignment of the polarizing layer POL, can be clearly set even when the corner of the display panel PNL (e.g., the first corner EG1) has a rounded shape.

In one or more embodiments, the operation of setting the second reference point RP2 may include the operation of setting, in the image IMG, a 2-1-th reference line segment RL2-1 overlapping a portion of the visibility enhancement component LBL adjacent to the second corner EG2, the operation of setting, in the image IMG, a 2-2-th reference line segment RL2-2 overlapping another portion of the visibility enhancement component LBL adjacent to the second corner EG2, and the operation of setting an intersection point between an extension line of the 2-1-th reference line segment RL2-1 and an extension line of the 2-2-th reference line segment RL2-2 to the second reference point RP2.

As such, the second reference point RP2 may be set based on the visibility enhancement component LBL. Accordingly, even in the case where it is substantially impossible to identify the edge of the polarizing layer POL because the polarizing layer POL and the light control layer LCF are relatively close to each other, the second reference point RP2 can be suitably set based on the visibility enhancement component LBL. As described with reference to FIG. 5, the line width W of the visibility enhancement component LBL is set to be suitably distinguished and identified from the plurality of light-blocking components 320, thereby reducing or preventing the likelihood of the issue of the plurality of light-blocking components 320 being misrecognized as the visibility enhancement component LBL during the setting of the second reference point RP2.

In one or more embodiments, the operation of determining the relative position of the second reference point RP2 may include the operation of determining a first spacing distance between the first reference point RP1 and the second reference point RP2 based on a first reference direction (e.g., the first direction DR1) in the image IMG, and the operation of determining a second spacing distance between the first reference point RP1 and the second reference point RP2 based on a second reference direction (e.g., the second direction DR2) that is substantially perpendicular to the first reference direction in the image IMG.

In this case, operation S20 of inspecting for misalignment of the polarizing layer POL may include the operation of comparing the first spacing distance with the first reference distance, and the operation of comparing the second spacing distance with the second reference distance. Here, the first reference distance and the second reference distance may each be set as distances that serve as criteria for determining whether the polarizing layer POL is misaligned with respect to the display panel PNL. That is, operation S20 of inspecting for misalignment of the polarizing layer POL may include the operation of determining that the polarizing layer POL is normally aligned in the case where the first spacing distance is less than or equal to the first reference distance, and the second spacing distance is less than or equal to the second reference distance. In other words, it is determined that misalignment of the polarizing layer POL has occurred when the first spacing distance exceeds the first reference distance, and/or when the second spacing distance exceeds the second reference distance.

In accordance with embodiments of the present disclosure, a polarizing layer may be clearly identified and distinguished from other components by a visibility enhancement component located along an edge of the polarizing layer. Therefore, whether the polarizing layer is misaligned can be clearly determined.

A display device according to one or more embodiments is applicable to various types of electronic devices. In one or more embodiments, an electronic device includes the above-described display device and may further include other modules or devices having additional functions in addition to the display device.

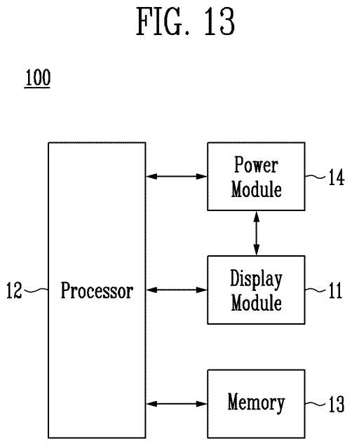

FIG. 13 is a block diagram of an electronic device according to one or more embodiments. Referring to FIG. 1, the electronic device 100 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data and/or information used to operate the processor 12 or the display module 11. When the processor 12 executes an application stored in the memory 13, image data signals and/or input control signals may be transferred to the display module 11. The display module 11 may process the provided signals and output image information on a display screen.

The power module 14 may include a power supply module, such as a power adapter or a battery device, and a power conversion module. The power conversion module converts power supplied by the power supply module and generates power to operate the electronic device 100.

At least one of the above-described components of the electronic device 100 may be included in the display device according to embodiments as described above. In addition, in terms of functionality, some of the individual modules included in one module may be included in the display device and others may be provided separately from the display device. For example, the display module 11 is included in the display device, whereas the processor 12, the memory 13, and the power module 14 are not included in the display device and are instead provided separately in the electronic device 100.

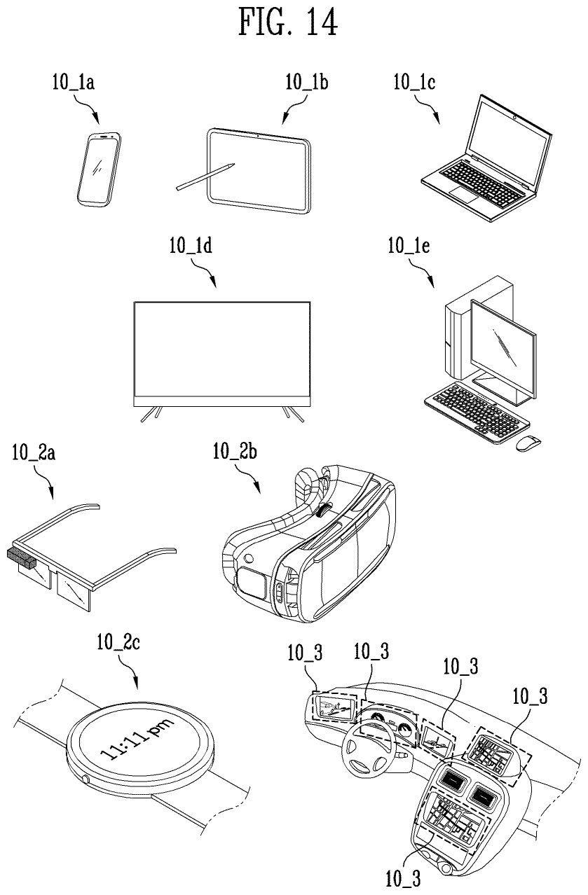

FIG. 14 shows schematic views of various embodiments of an electronic device.

Referring to FIG. 14, various types of electronic devices to which embodiments of a display device are applied may include an electronic device to display images, such as a smartphone 10_1a, a tablet PC 10_1b, a laptop computer 10_1c, a television (TV) 10_1d, and a desktop monitor 10_1e, a wearable electronic device including a display module, such as smart glasses 10_2a, a head-mounted display (HMD) 10_2b, and a smart watch 10_2c, and an automotive electronic device 10_3 including a display module, such as a center information display (CID) located at the instrument cluster, the center fascia, and the dashboard of a vehicle, and a room mirror display.

While embodiments have been described above, those skilled in the art will appreciate that various modifications, additions and substitutions are possible, without departing from the scope and spirit of the present disclosure claimed in the appended claims, with functional equivalents thereof to be included therein.

What is claimed is:

1. A display device comprising:
a display panel comprising pixels in a display area;
a light control layer over the display panel, and comprising light-blocking components arranged in a second direction, and extending in a first direction crossing the second direction;
a polarizing layer over the light control layer; and
a visibility enhancement component along an edge of the polarizing layer in plan view.

2. The display device according to claim 1, wherein the visibility enhancement component has a linear shape in plan view.

3. The display device according to claim 2, wherein a line width of the visibility enhancement component is greater than a width of each of the light-blocking components in the second direction.

4. The display device according to claim 3, wherein the line width of the visibility enhancement component is about 80 micrometers or more and about 120 micrometers or less.

5. The display device according to claim 1, wherein the visibility enhancement component overlaps a peripheral area around the display area.

6. The display device according to claim 1, wherein the visibility enhancement component comprises sub-visibility enhancement components spaced apart from each other, and at edges of the polarizing layer adjacent to corners of the polarizing layer in plan view.

7. The display device according to claim 1, wherein the polarizing layer comprises:
an adhesive layer over the light control layer;
functional layers over the adhesive layer; and
a protective film layer over the functional layers.

8. The display device according to claim 7, wherein the visibility enhancement component is over the protective film layer.

9. The display device according to claim 7, wherein the visibility enhancement component is between the protective film layer and the functional layers.

10. The display device according to claim 7, wherein the visibility enhancement component is between two adjacent ones of the functional layers.

11. The display device according to claim 1, wherein the visibility enhancement component comprises a light-blocking material.

12. A method of inspecting a display device comprising a display panel comprising pixels in a display area, a light control layer over the display panel and comprising light-blocking components arranged in a second direction and extending in a first direction crossing the second direction, a polarizing layer over the light control layer, and a visibility enhancement component along an edge of the polarizing layer in plan view, the method comprising:
identifying the visibility enhancement component from an image captured of the display device; and
inspecting for misalignment of the polarizing layer based on the visibility enhancement component.

13. The method according to claim 12, wherein the inspecting for the misalignment of the polarizing layer comprises:
setting a first reference point corresponding to a first corner of the display panel in the image;
setting a second reference point corresponding to a second corner of the polarizing layer adjacent to the first corner in the image; and
determining a relative position of the second reference point based on a position of the first reference point.

14. The method according to claim 13, wherein the setting the first reference point comprises:
setting a 1-1-th reference line segment overlapping an edge of the display panel adjacent to the first corner in the image;
setting a 1-2-th reference line segment overlapping another edge of the display panel adjacent to the first corner in the image; and
setting an intersection point of an extension line of the 1-1-th reference line segment and an extension line of the 1-2-th reference line segment to the first reference point.

15. The method according to claim 14, wherein the setting the second reference point comprises:
setting a 2-1-th reference line segment overlapping a portion of the visibility enhancement component adjacent to the second corner in the image;
setting a 2-2-th reference line segment overlapping another portion of the visibility enhancement component adjacent to the second corner in the image; and
setting another intersection point of an extension line of the 2-1-th reference line segment and an extension line of the 2-2-th reference line segment to the second reference point.

16. The method according to claim 13, wherein the determining the relative position of the second reference point comprises:
determining a first spacing distance between the first reference point and the second reference point based on a first reference direction in the image; and
determining a second spacing distance between the first reference point and the second reference point based on a second reference direction that is substantially perpendicular to the first reference direction in the image.

17. The method according to claim 16, wherein the inspecting for the misalignment of the polarizing layer comprises:
comparing the first spacing distance with a first reference distance; and
comparing the second spacing distance with a second reference distance.

18. The method according to claim 17, wherein the inspecting for the misalignment of the polarizing layer comprises determining that the polarizing layer has been normally aligned when the first spacing distance is less than or equal to the first reference distance, and the second spacing distance is less than or equal to the second reference distance.

19. An electronic device comprising:
a display device configured to display an image, and comprising:
a display panel comprising pixels in a display area;
a light control layer over the display panel, and comprising light-blocking components arranged in a second direction and extending in a first direction crossing the second direction;
a polarizing layer over the light control layer; and
a visibility enhancement component along an edge of the polarizing layer in plan view.

20. The electronic device of claim 19, wherein the electronic device comprises a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, a head-mounted display (HMD), a virtual reality (VR) device, an augmented reality (AR) device, a dashboard of a vehicle, a center information display (CID), or a mirror display.
